(19) United States
(12) Patent Application Publication
(10) Pub. No.: US 2026/0151997 A1
(43) Pub. Date: Jun. 4, 2026

(54) LIQUID DISCHARGE HEAD, HEAD MODULE, AND LIQUID DISCHARGE APPARATUS

(71) Applicants: Yukimasa MATSUDA, Kanagawa (JP); Keishi MIWA, Kanagawa (JP); Toshiaki MASUDA, Kanagawa (JP)

(72) Inventors: Yukimasa MATSUDA, Kanagawa (JP); Keishi MIWA, Kanagawa (JP); Toshiaki MASUDA, Kanagawa (JP)

(21) Appl. No.: 19/352,498

(22) Filed: Oct. 8, 2025

(30) Foreign Application Priority Data
Dec. 4, 2024 (JP) 2024-211542

(51) Int. Cl. B41J 2/14; B41J 2/16; B41J 2/21; B41J 25/00

(52) U.S. Cl. CPC B41J 2/14233; B41J 2/1433; B41J 2/161; B41J 2/1623; B41J 2/2103; B41J 25/005; B41J 2002/14306

(57) ABSTRACT

A liquid discharge head includes a nozzle substrate having multiple nozzles, a pressure chamber substrate having pressure chambers, a first substrate, and a second substrate. The first substrate has a common channel, a first face opposed to the pressure chamber substrate, a second face opposite the first face, a first rigidity portion having a first rigidity, and a second rigidity portion having a second rigidity lower than the first rigidity. The second substrate has a third face opposed to the second face of the first substrate, a fourth face opposite the third face, a third rigidity portion having a third rigidity, and a fourth rigidity portion having a fourth rigidity lower than the third rigidity. The third rigidity portion is joined to the second rigidity portion of the first substrate, and the fourth rigidity portion is joined to the first rigidity portion of the first substrate.

### CROSS-REFERENCE TO RELATED APPLICATION

This patent application is based on and claims priority pursuant to 35 U.S.C. § 119 (a) to Japanese Patent Application No. 2024-211542, filed on Dec. 4, 2024, in the Japan Patent Office, the entire disclosure of which is hereby incorporated by reference herein.

### BACKGROUND

### Technical Field

The present disclosure relates to a liquid discharge head, a head module, and a liquid discharge apparatus.

### Related Art

A liquid discharge head is formed by laminating a nozzle substrate (nozzle member) having multiple nozzles, a channel substrate (pressure chamber member) having pressure chambers communicating with the nozzles, a common channel member (first substrate) having a common channel communicating with the pressure chambers, a damper frame (second substrate) joined to the common channel member via a damper.

### SUMMARY

The present disclosure described herein provides an improved liquid discharge head including a nozzle substrate, a pressure chamber substrate, a first substrate, and a second substrate. The nozzle substrate has multiple nozzles. The pressure chamber substrate is disposed over the nozzle substrate. The pressure chamber substrate has pressure chambers respectively communicating with the multiple nozzles. The first substrate is disposed over the pressure chamber substrate. The first substrate has a common channel communicating with each of the pressure chambers, a first face opposed to the pressure chamber substrate, a second face opposite the first face, a first rigidity portion having a first rigidity, and a second rigidity portion having a second rigidity lower than the first rigidity. The second substrate is disposed over the first substrate. The second substrate has a third face opposed to the second face of the first substrate, a fourth face opposite the third face, a third rigidity portion having a third rigidity, and a fourth rigidity portion having a fourth rigidity lower than the third rigidity. The third rigidity portion is joined to the second rigidity portion of the first substrate, and the fourth rigidity portion is joined to the first rigidity portion of the first substrate.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is an exploded perspective view of a head module including a liquid discharge head;

FIG. 2 is an exploded perspective view of the head module of FIG. 1 as viewed from a nozzle face side;

FIG. 3 is a cross-sectional view of the head module of FIG. 1 taken along a transverse direction of a head;

FIG. 4 is a cross-sectional view of a holding substrate;

FIG. 5 is a plan view of a face of a first substrate facing on a nozzle face side;

FIG. 6 is a plan view of a face of a second substrate on a first substrate side according to a comparative example;

FIG. 7 illustrates a cross-sectional view of the second substrate of FIG. 6 joined to the first substrate of FIG. 5 taken along line A-A′ of FIG. 5 in a part (a) and a diagram illustrating a discharge speed of ink from each nozzle in a part (b);

FIG. 8 is a plan view of a face of a second substrate on a frame side;

FIG. 9 is a plan view of a first substrate superimposed on a second substrate in an actual lamination direction in a liquid discharge head, illustrating a projection forming a pseudo channel of the second substrate;

FIG. 10 illustrates a cross-sectional view of the second substrate of FIG. 8 joined to the first substrate of FIG. 5 taken along line B-B′ of FIG. 8 in a part (a) and a diagram illustrating a discharge speed of ink from each nozzle in a part (b);

FIG. 11 is a cross-sectional view of a first substrate and a second substrate, illustrating a depth of a common channel of the first substrate and a depth of a pseudo channel of the second substrate;

FIG. 12 is a schematic view of a liquid discharge apparatus;

FIG. 13 is a plan view of the liquid discharge apparatus of FIG. 12;

FIG. 14 is a plan view of a part of another liquid discharge apparatus;

FIG. 15 is a side view of the part of the liquid discharge apparatus of FIG. 14;

FIG. 16 is a plan view of a liquid discharge unit; and

FIG. 17 is a front view of another liquid discharge unit.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

In a comparative example, a liquid discharge head is formed by laminating a nozzle substrate having multiple nozzles, a channel substrate having pressure chambers communicating with the nozzles, a common channel substrate having a common channel communicating with the pressure chambers, a damper substrate joined to the common channel substrate via a damper. In such a liquid discharge head, grooves are formed in these substrates, and thus the rigidity thereof varies depending on the location. For this reason, for example, when stress is applied to the substrates due to heating at the time of bonding and subsequent cooling of these substrates, large deformation such as warpage may occur in a portion having low rigidity.

Embodiments of the present disclosure are described below with reference to the drawings. In the drawings, like reference signs denote like elements, and overlapping descriptions may be simplified or omitted as appropriate.

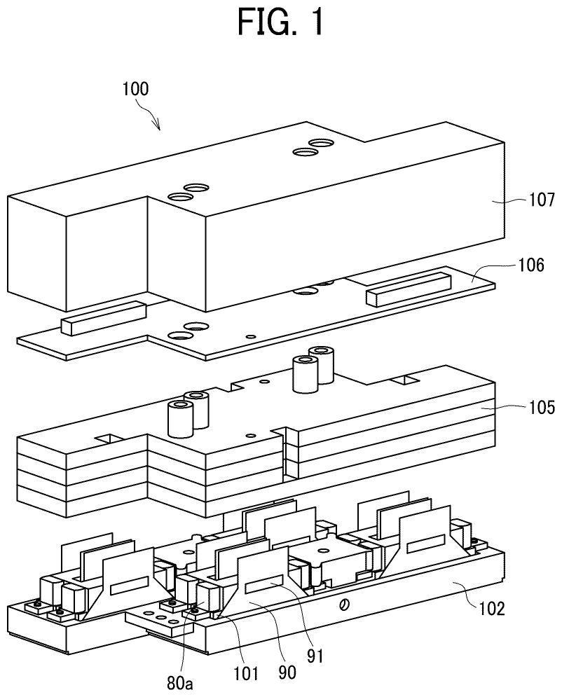

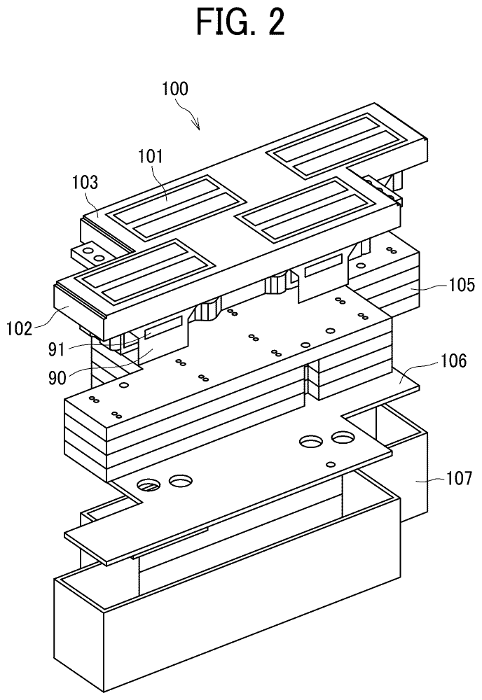

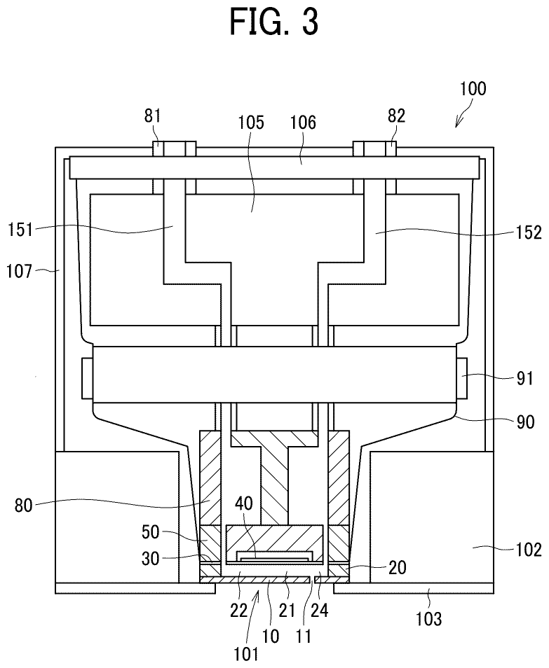

A liquid discharge head and a head module including the liquid discharge head will be described below with reference to FIGS. 1 to 3. FIG. 1 is an exploded perspective view of a head module 100. FIG. 2 is an exploded perspective view of the head module 100 as viewed from a nozzle face side. FIG. 3 is a cross-sectional view of the head module 100 taken in a head transverse direction.

As illustrated in FIGS. 1 and 2, the head module 100 includes multiple heads 101 serving as the liquid discharge heads to discharge a liquid, a base 102, a cover 103, a manifold 105, a printed circuit board (PCB) 106, and a module case 107.

As illustrated in FIG. 3, each of the heads 101 includes a nozzle substrate 10 as a nozzle substrate, a channel substrate 20 as a pressure chamber substrate, a diaphragm 30, a holding substrate 50, and a frame 80. Each of the heads 101 is an example of the liquid discharge head.

The nozzle substrate 10 has multiple nozzles 11. The channel substrate 20 is disposed over the nozzle substrate 10 and has pressure chambers 21 communicating with the nozzles 11. The pressure chamber 21 may be referred to as, for example, an individual liquid chamber. The diaphragm 30 forms a part of the pressure chamber 21 and is vibrated by a piezoelectric element 40. The holding substrate 50 is laminated over the diaphragm 30. The frame 80 is laminated over the holding substrate 50.

The channel substrate 20 forms, in addition to the pressure chambers 21, supply-side individual channels 22 communicating with the pressure chambers 21 and collection-side individual channels 24 communicating with the pressure chambers 21. The channel substrate 20 may be referred to as, for example, an individual channel plate.

A supply inlet 81 communicates with a supply-side common channel on the holding substrate 50 side via a channel 151 of the manifold 105. A collection outlet 82 communicates with a collection-side common channel on the holding substrate 50 side via a channel 152 of the manifold 105.

The PCB 106 and the piezoelectric element 40 of the head 101 are coupled via a flexible wiring 90. As illustrated in FIG. 2, the flexible wiring 90 is provided with a driver integrated circuit (IC) 91 (i.e., a drive circuit).

As illustrated in FIGS. 1 and 2, the multiple heads 101 are mounted on the base 102 at intervals. The head 101 is mounted on the base 102 such that the head 101 is inserted into an opening in the base 102, and a peripheral edge portion of the nozzle substrate 10 of the head 101 is joined and fixed to the cover 103 joined to the base 102. The head 101 includes a flange 80a outside the frame 80. The flange 70a is joined and fixed to the base 102.

A structure for fixing the head 101 to the base 102 is not limited to any particular structure. For example, the head 101 may be fixed to the base 102 through bonding, caulking, swaging, riveting, or screwing.

The base 102 is preferably made of a material having a low coefficient of linear expansion. For example, 42Alloy that is alloy of iron with nickel or an invar material may be used. In the present embodiment, the invar material is used. Accordingly, since an amount of expansion of the base 102 is small even when the head 101 generates heat and a temperature of the base 102 rises, the nozzle is less likely to shift from a predetermined nozzle position. As a result, a landing position of the liquid can be prevented from deviating from a desired position.

Each of the nozzle substrate 10, the channel substrate 20, and the diaphragm 30 is made of monocrystalline silicon substrate, and has substantially the same coefficient of linear expansion as the base 102. Thus, the deviation of the nozzle due to thermal expansion can be reduced.

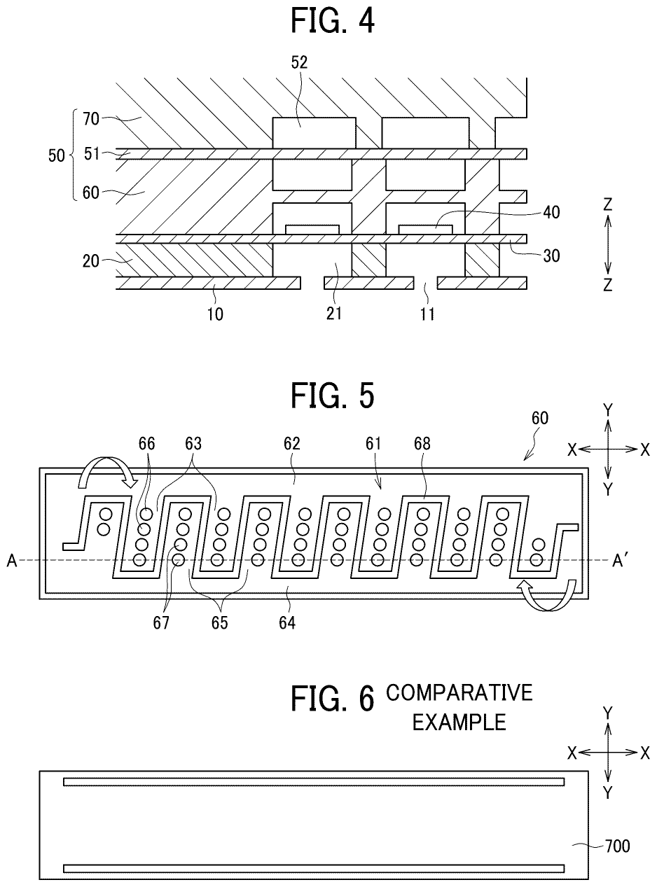

As illustrated in FIG. 4, the holding substrate 50 is formed by laminating a first substrate 60, a damper 51, and a second substrate 70 one on another. In other words, the second substrate 70 is laminated over the first substrate 60 in a lamination direction orthogonal to a plane of the first substrate 60. The first substrate 60 has a common channel to be described later. The common channel communicates with the pressure chamber 21 via a supply port to supply ink as liquid to the pressure chamber 21.

Each piezoelectric element 40 is opposed to the corresponding pressure chamber 21 via the diaphragm 30. The piezoelectric element 40 is an electromechanical transducer, and is a pressure generator that deforms the diaphragm 30 to pressurize the ink in the pressure chamber 21. When the ink in each pressure chamber 21 is pressurized, the ink is discharged from the nozzle 11 communicating with the pressure chamber 21.

The damper 51 is held between the first substrate 60 and the second substrate 70. Each of the first substrate 60 and the second substrate 70 has a recess forming a damper space 52. The damper 51 vibrates in the damper space 52 to attenuate vibration in the liquid discharge head generated by the pressure of the piezoelectric element 40.

FIG. 5 is a plan view of a face (upper face in FIG. 4) of the first substrate 60 on the damper side. In FIG. 5, the recess forming a damper chamber is omitted. A left-right direction X in FIG. 5 is a longitudinal direction of the first substrate 60 and the second substrate 70. An up-down direction Y in FIG. 5 is a transverse direction of the first substrate 60 and the second substrate 70. A direction (direction Z in FIG. 4) orthogonal to the surface of the paper on which FIG. 5 is drawn is a thickness direction of the first substrate 60 and the second substrate 70, the lamination direction of these substrates, or a direction parallel to a liquid discharge direction from the nozzle 11. The longitudinal direction, the transverse direction, and the thickness direction are orthogonal to each other.

As illustrated in FIG. 5, the first substrate 60 has a recess forming a common channel 61. The common channel 61 includes a supply-side main flow section 62 extending in the longitudinal direction of the first substrate 60 and communicating with the supply inlet 81, multiple supply-side branch flow sections 63 branching from the supply-side main flow section 62, a collection-side main flow section 64 communicating with the collection outlet 82, and multiple collection-side branch flow sections 65 branching from the collection-side main flow section 64.

Each supply-side branch flow section 63 is provided with multiple supply ports 66 communicating with the pressure chambers 21. Each collection-side branch flow section 65 is provided with multiple collection ports 67 communicating with the pressure chambers 21. A wall portion 68 in FIG. 5 that partitions each of the flow sections and an outer peripheral portion of the first substrate 60 are projections of the first substrate 60, and the other portion, in particular, the portion of the common channel 61 is a recess. In other words, the wall portion 68 extends substantially in the longitudinal direction of the first substrate 60 even while meandering in the transverse direction of the first substrate 60. The first substrate 60 has an uneven shape including the projection and the recess. The projection (i.e., a first projection) projects in the lamination direction and forms the wall portion 68 (i.e., a first wall portion), and the recess (i.e., a first recess) forms a bottom of the first wall portion.

Each of the supply-side branch flow sections 63 and the collection-side branch flow sections 65 extends from the lower left to the upper right in FIG. 5 and is inclined with respect to a long side and a short side of the first substrate 60. Accordingly, on a plane orthogonal to the thickness direction of the first substrate 60, the first substrate 60 has relatively low rigidity at the upper left and lower right portions in FIG. 5. For example, on the surface of the paper on which FIG. 5 is drawn, when the first substrate 60 is divided into two in the longitudinal direction and the transverse direction, i.e., divided into four regions in the up-down and left-right directions, rigidity (i.e., a second rigidity) of the upper left and lower right regions of the first substrate 60 is lower than the rigidity (i.e., a first rigidity) of the lower left and upper right regions.

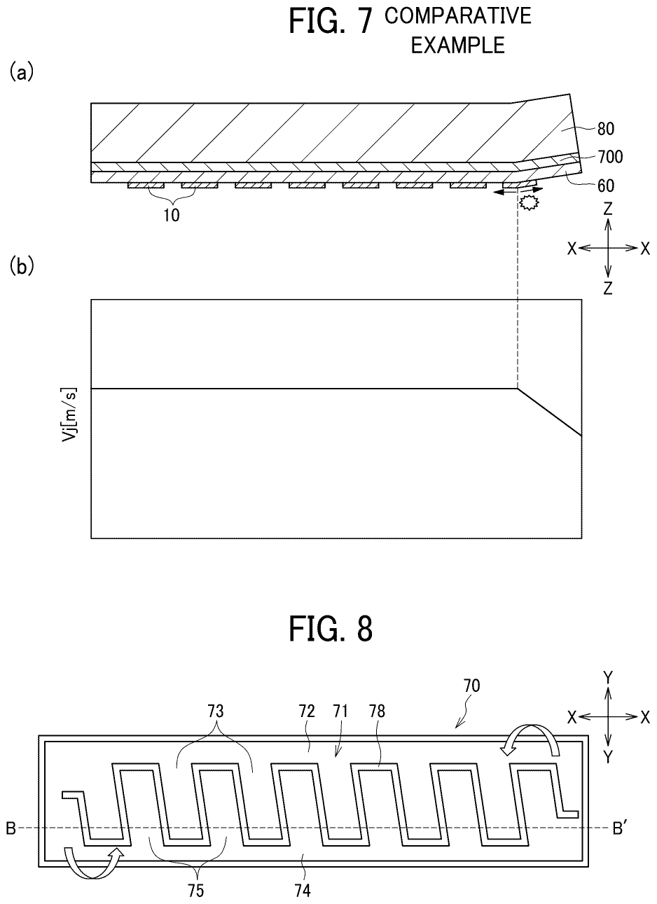

FIG. 6 is a plan view of a face (upper face in FIG. 4) of a second substrate 700 on the frame side, which is different from that in the above embodiment (i.e., a comparative example). FIG. 7 illustrates a cross-sectional view of the second substrate 700 joined to the first substrate 60 taken along line A-A′ of FIG. 5 in a part (a), which indicates a state of deformation generated at an end of these substrates in the longitudinal direction. Further, FIG. 7 illustrates a diagram illustrating a discharge speed Vj of ink from each nozzle in a part (b). The left-right direction in FIG. 7 is a nozzle array direction or the longitudinal direction of the first substrate 60 and the second substrate 700, and the part (b) of FIG. 7 is a line graph connecting values of the discharge speeds Vj of ink discharged from the respective nozzles.

As illustrated in FIG. 6, the second substrate 700 has a flat face on the center side and has no recess. In other words, the second substrate 700 has no significant variation in rigidity by location.

Although the damper 51 is omitted in the part (a) of FIG. 7, the first substrate 60, the damper 51, the second substrate 700, and the frame 80 are laminated and joined in this order. As described above, the first substrate 60 has variation in rigidity (i.e., a first variation in rigidity) across the plane of the first substrate 60 due to the inclination of the common channel, and the second substrate 700 has no significant variation in rigidity. Accordingly, when the first substrate 60 and the second substrate 700 are laminated as illustrated in the part (a) of FIG. 7 to form a joined substrate, the joined substrate of the first substrate 60 and the second substrate 700 has variation in rigidity corresponding to the variation in rigidity of the first substrate 60.

For example, the frame 80 is made of a polymer resin. On the other hand, the first substrate 60 and the second substrate 700 are made of a silicon substrate, and there is a large difference in coefficient of linear expansion. Thus, when an adhesive is applied between these substrates and heated and cured, stress is generated in each substrate at the time of cooling after heating and curing due to a difference in coefficient of linear expansion. When such a stress is generated, the joined substrate of the first substrate 60 and the second substrate 700 is distorted due to an imbalance in rigidity of the joined substrate. As illustrated in the part (a) of FIG. 7, the right side in FIG. 7, which is a low rigidity side of the first substrate 60, in other words, the upper left and lower right portions in FIG. 5 are warped and deformed in the directions indicated by the outlined arrows in FIG. 5. Accordingly, in this deformed portion, as illustrated on the right side of the part (b) of FIG. 7, the discharge speed Vj of ink may decrease.

FIG. 8 is a plan view of a face (upper face in FIG. 4) of the second substrate 70 on the frame side according to the present embodiment. In FIG. 8, other recesses on the face of the second substrate 70 on the frame side are omitted.

As illustrated in FIG. 8, the second substrate 70 has a recess forming a pseudo channel 71 on the face thereof. The pseudo channel 71 is formed on the face of the second substrate 70, which is the face illustrated in FIG. 8, opposite to the first substrate 60 side. The pseudo channel 71 is a rigidity adjuster to adjust the rigidity of the second substrate 70 at each location by the recess. Ink does not flow in the pseudo channel 71.

The pseudo channel 71 includes a first pseudo main flow section 72 extending in the longitudinal direction of the second substrate 70, multiple first pseudo branch flow sections 73 branching from the first pseudo main flow section 72, a second pseudo main flow section 74 extending in the longitudinal direction of the second substrate 70, and multiple second pseudo branch flow sections 75 branching from the second pseudo main flow section 74. A wall portion 78 that partitions each of the pseudo flow sections of the second substrate 70 is a projection, and the other portion, in particular, the portion of the pseudo channel 71 is a recess. The second substrate 70 has an uneven shape including the projection and the recess. The projection (i.e., a second projection) projects in the lamination direction and forms the wall portion 78 (i.e., a second wall portion), and the recess (i.e., a second recess) forms a bottom of the second wall portion.

Each of the first pseudo branch flow sections 73 and the second pseudo branch flow sections 75 is inclined in a direction from the upper left to the lower right in FIG. 8. By forming the pseudo channel 71 in the second substrate 70, the second substrate 70 has relatively low rigidity (i.e., a fourth rigidity) at the lower left and upper right portions in FIG. 8 on a plane orthogonal to the thickness direction of the second substrate 70, which is lower than the rigidity (i.e., a third rigidity) of the lower right and upper left portions of the second substrate 70.

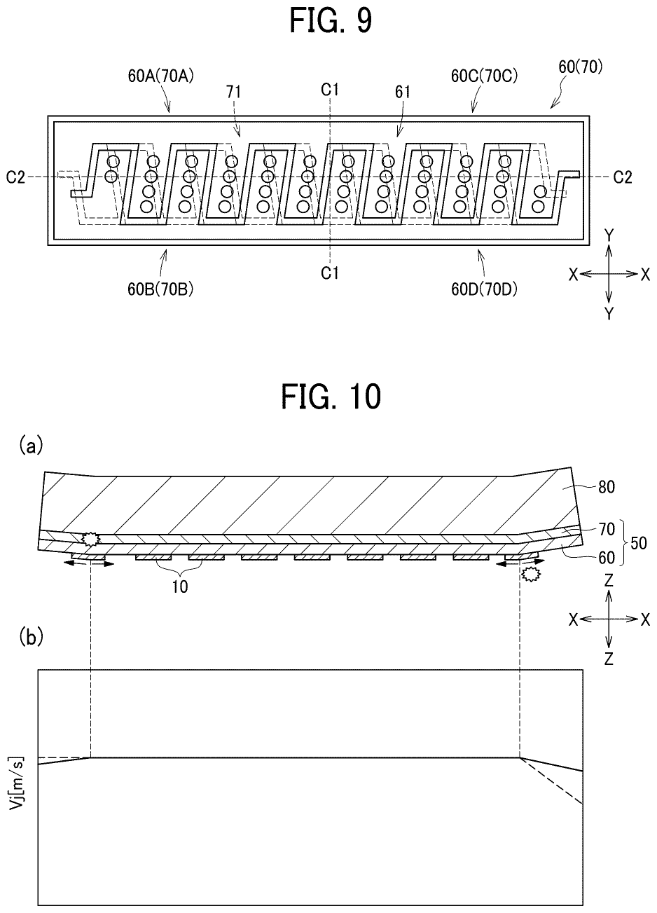

FIG. 9 is a plan view of the first substrate 60 of FIG. 5 superimposed on the second substrate 70 of FIG. 8 in an actual lamination direction in the liquid discharge head 101, illustrating the projection forming the pseudo channel 71 of the second substrate 70. As described above, the pseudo channel 71 is disposed on the face (i.e., a fourth face of the second substrate 70) opposite the face (i.e., a third face of the second substrate 70) of the first substrate 60 side, and the face (i.e., a second face opposite a first face opposed to the pressure chamber substrate) of the first substrate 60 on which the common channel 61 is formed and a flat face (i.e., the third face) of the second substrate 70 on which the pseudo channel 71 is not formed are joined (opposed) to each other. Although the pseudo channel 71 is indicated by the dashed line for the sake of convenience in FIG. 9, actually, when viewed in FIG. 9, the face of the second substrate 70 on which the pseudo channel 71 is formed (the upper face of the second substrate 70 in FIG. 4) is disposed on a front side of the face of the first substrate 60 on which the common channel 61 is formed (the upper face of the first substrate 60 in FIG. 4) in the direction orthogonal to the surface of the paper on which FIG. 9 is drawn. The common channel 61 and the pseudo channel 71 are recesses that do not penetrate the first substrate 60 and the second substrate 70 in the thickness direction, respectively, except for the supply ports 66 and the collection ports 67 of the common channel 61.

As illustrated in FIG. 9, the branch flow sections 63 and 65 (see FIG. 5) of the common channel 61 of the first substrate 60 are inclined in a direction (i.e., a first inclined direction) from the lower left to the upper right of FIG. 9. On the other hand, the branch flow sections 73 and 75 (see FIG. 8) of the pseudo channel 71 are inclined in a direction (i.e., a second inclined direction different from the first inclined direction) from the lower right to the upper left of FIG. 9. Thus, the inclination direction is opposite. In other words, the branch flow sections 63 and 65 are inclined toward one side with respect to the transverse direction of the first substrate 60 and the second substrate 70, and the branch flow sections 73 and 75 are inclined toward another side opposite to the one side with respect to the transverse direction.

As described above, the rigidity of the upper left and lower right portions in FIG. 9 of the first substrate 60 is low due to the common channel 61, and the rigidity of the lower left and upper right portions of FIG. 9 of the second substrate 70 is low due to the pseudo channel 71. In other words, the level of the rigidity is reversed between the first substrate 60 and the second substrate 70. Thus, when the second substrate 70 is laminated over the first substrate 60, the high rigidity portion of the first substrate 60 can overlap the low rigidity portion of the second substrate 70, and the low rigidity portion of the first substrate 60 can overlap the high rigidity portion of the second substrate 70. As a result, variations in rigidity can be reduced at positions on the plane orthogonal to the thickness direction of the first substrate 60. In other words, the pseudo channel 71 as the rigidity adjuster is formed in the second substrate 70 to adjust the rigidity for each position so as to reduce the variations in rigidity in the joined substrate (i.e., the holding substrate 50) in which the first substrate 60 and the second substrate 70 are laminated one on another.

Each of the first substrate 60 and the second substrate 70 is divided into four at a center position C1 in the longitudinal direction and a center position C2 in the transverse direction of the first substrate 60 (or the second substrate 70). In other words, the first substrate 60 is divided into an upper left region 60A, a lower left region 60B, an upper right region 60C, and a lower right region 60D, and the second substrate 70 is divided into an upper left region 70A, a lower left region 70B, an upper right region 70C, and a lower right region 70D. In this case, in the first substrate 60, the lower left region 60B and the upper right region 60C are first high rigidity regions having relatively high rigidity in the first substrate 60, and the upper left region 60A and the lower right region 60D are first low rigidity regions having relatively low rigidity in the first substrate 60. In the second substrate 70, the lower left region 70B and the upper right region 70C are second low rigidity regions having relatively low rigidity in the second substrate 70, and the upper left region 70A and the lower right region 70D are second high rigidity regions having relatively high rigidity in the second substrate 70. In other words, the first high rigidity regions of the first substrate 60 overlap the second low rigidity regions of the second substrate 70, and the first low rigidity regions of the first substrate 60 overlap the second high rigidity regions of the second substrate 70 when the second substrate 70 is laminated over and joined to the first substrate 60. Thus, in the joined substrate of the first substrate 60 and the second substrate 70, variations in rigidity at positions can be reduced on the plane orthogonal to the thickness direction (on the face illustrated in FIG. 9).

The first high rigidity regions of the first substrate 60 are referred to as a first high rigidity portion (or a first rigidity portion), the first low rigidity regions of the first substrate 60 are referred to as a first low rigidity portion (or a second rigidity portion), the second high rigidity regions of the second substrate 70 are referred to as a second high rigidity portion (or a third rigidity portion), and the second low rigidity regions of the second substrate 70 are referred to as a second low rigidity portion (or a fourth rigidity portion). In the present embodiment, the first high rigidity portion is overlapped with and joined to the second low rigidity portion, and the first low rigidity portion is overlapped with and joined to the second high rigidity portion. As a result, variations in rigidity of the holding substrate 50 (i.e., the joined substrate) in which the first substrate 60 and the second substrate 70 are joined to each other can be reduces. Thus, deformation of the holding substrate 50, in particular, partial, excessive deformation can be prevented, for example, during heating and cooling at the time of joining. Accordingly, a decrease in the discharge speed of liquid from the nozzles, in particular, a decrease in the discharge speed of liquid from the nozzles disposed at the end in the longitudinal direction can be prevented.

However, as in the above embodiment, the first low rigidity portion and the first high rigidity portion, and the second low rigidity portion and the second high rigidity portion are not necessarily formed in the respective divided regions of the first substrate and the second substrate, and a part of the first substrate or the second substrate may be defined as the first low rigidity portion or the second low rigidity portion. For example, a portion of the first substrate 60 where the recess is formed, i.e., a portion where the common channel 61 is formed is defined as the first low rigidity portion, other projections are defined as the first high rigidity portion, the recess of the second substrate 70, i.e., a portion of the pseudo channel 71 is defined as the second low rigidity portion, and other projections of the second substrate 70 are defined as the second high rigidity portion. A part of the first high rigidity portion (e.g., the first projection) may be overlapped with and joined to a part of the second low rigidity portion (e.g., the second recess), and a part of the first low rigidity portion (e.g., the first recess) may be overlapped with and joined to a part of the second high rigidity portion (e.g., the second projection) to form the holding substrate 50. As a result, variations in rigidity of the holding substrate 50 (i.e., the joined substrate) in which the first substrate 60 and the second substrate 70 are joined to each other can be reduced, and thus deformation of the first substrate 60 can be prevented. In the present embodiment, a small variation in rigidity (i.e., a second variation smaller than the first variation in rigidity) of the holding substrate 50 in which the first substrate 60 and the second substrate 70 are joined to each other means that the holding substrate 50 in which the first substrate 60 and the second substrate 70 are joined to each other has a small deviation in rigidity at positions on the plane orthogonal to the lamination direction. In particular, the small variation in rigidity means that the difference in rigidity between the maximum rigidity position and the minimum rigidity position is small. For example, as described above, a region having high rigidity of the first substrate is joined to a region having low rigidity of the second substrate, and a region having low rigidity of the first substrate is joined to a region having high rigidity of the second substrate, to join a portion having high rigidity to a portion having low rigidity in units of regions, so that variations in rigidity can be reduced.

In the second substrate 70, the thicknesses of a part or all of the upper left region 70A and the lower right region 70D joined to the low rigidity regions of the first substrate 60 may be larger than the thicknesses of the lower left region 70B and the upper right region 70C. Thus, the rigidity of the portion of the second substrate 70 corresponding to the low rigidity region of the first substrate 60 can be further increased, and the variation in the rigidity of the holding substrate 50 in which the first substrate 60 and the second substrate 70 are joined to each other can be reduced. Accordingly, deformation of the first substrate 60 can be prevented, and a decrease in the discharge speed of liquid from the nozzles can be prevented.

In particular, the pseudo channel 71 in the second substrate 70 coincides with the common channel 61 of the first substrate 60 rotated by 180 degrees about the axis (i.e., a central axis) of the center position C1 in the longitudinal direction as viewed in FIG. 9, i.e., as viewed in the lamination direction in the actual liquid discharge head. With such a configuration, in particular, the variations in rigidity of the holding substrate 50 in which the first substrate 60 and the second substrate 70 are joined to each other can be reduced, and the deformation of the first substrate 60 can be further prevented. However, the pseudo channel 71 may not exactly coincide with the common channel 61. For example, parts of the branch sections of the first substrate 60 and the second substrate 70 coincide with each other.

FIG. 10 illustrates a cross-sectional view of the second substrate 70 joined to the first substrate 60 taken along line B-B′ of FIG. 8 in a part (a), which indicates a state of deformation generated at an end of these substrates in the longitudinal direction. Further, FIG. 10 illustrates a diagram illustrating the discharge speed Vj of ink from each nozzle in a part (b). The solid line in the part (b) of FIG. 10 indicates the discharge speed in the present embodiment, and the dashed line in the part (b) of FIG. 10 indicates the discharge speed in the part (b) of FIG. 7 in the comparative example.

As indicated by the solid line in the part (a) of FIG. 10, the first substrate 60 and the second substrate 70 are deformed to the same extent at both ends in the longitudinal direction by reducing the deviation in rigidity. Accordingly, the comparison between the solid line and the dashed line in the part (b) of FIG. 10 indicates that the drop of the discharge speed Vj on the right side in the part (b) of FIG. 10 is smaller in the configuration of the present embodiment than in the configuration of the comparative example. As described above, the second substrate 70 of the present embodiment can prevent the partial, excessive deformation of the first substrate 60 and the drop of the discharge speed Vj.

The pseudo channel 71 is disposed on a face (upper face in FIG. 4) of the second substrate 70 on the frame 80 side opposite to the first substrate 60 side. Thus, the pseudo channel 71 is not opposed to the common channel 61 when the first substrate 60 and the second substrate 70 are joined to each other. Accordingly, a joint area between the first substrate 60 and the second substrate 70 via the damper 51 can be made large, and thus a decrease in joint strength between the first substrate 60 and the second substrate 70 due to the pseudo channel 71 can be prevented.

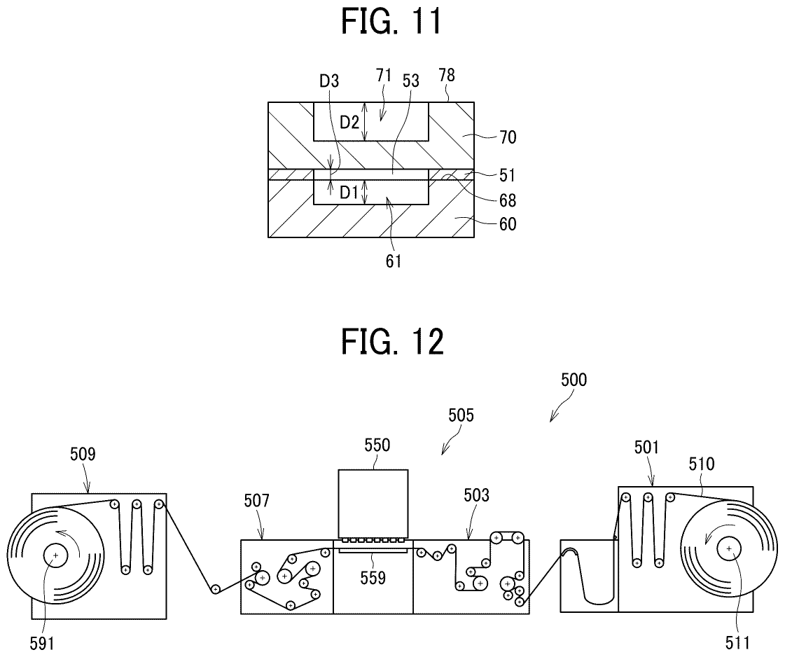

As illustrated in FIG. 11, the damper 51 has a damper-side common channel 53 communicating with the common channel 61 of the first substrate 60 to form a common channel of ink (i.e., a combined liquid channel). In FIG. 11, a recess depth D2 (i.e., a second depth) of the pseudo channel 71 of the second substrate 70 is preferably larger than a common channel depth that is the sum of a recess depth D1 (i.e., a first depth) of the common channel 61 of the first substrate 60 and a depth D3 (i.e., a damper depth) of the damper-side common channel 53. Due to such a configuration, the deviation in rigidity caused by the common channel 61 and the damper-side common channel 53 can be effectively reduced. The recess depth D2 of the pseudo channel 71 is a distance in the thickness direction from the top of the wall portion 78 as a projection to the bottom of the pseudo channel 71 as a recess. The recess depth D1 of the common channel 61 is a distance in the thickness direction from the top of the wall portion 68 as a projection to the bottom of the common channel 61 as a recess.

In the present embodiment, the first substrate 60 is joined to the second substrate 70 via the damper 51. As described above, the phrase “the first substrate and the second substrate are joined to each other” in the present disclosure may include a case where the first substrate and the second substrate are joined to each other via another component. Alternatively, the first substrate and the second substrate may be directly joined to each other without interposing another component such as a damper therebetween. In this case, in FIG. 11, the recess depth D2 of the pseudo channel 71 is preferably larger than the recess depth D1 of the common channel 61. Due to such a configuration, the deviation in rigidity caused by the common channel 61 can be effectively reduced.

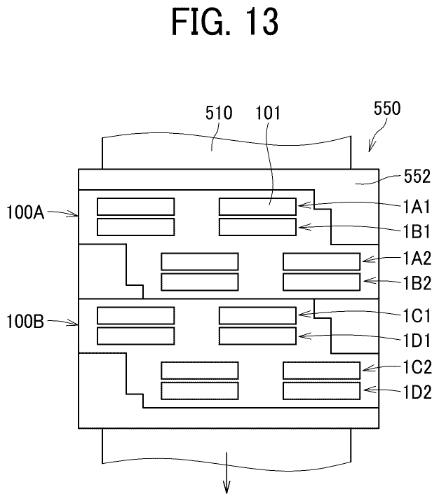

A liquid discharge apparatus is described below with reference to FIGS. 12 and 13. FIG. 12 is a schematic view of the liquid discharge apparatus. FIG. 13 is a plan view of a head unit of the liquid discharge apparatus.

A printer 500 as the liquid discharge apparatus includes a feeder 501 to feed a continuous medium 510, a guide conveyor 503 (i.e., a conveyor) to guide and convey the continuous medium 510, fed from the feeder 501, to a printing device 505, the printing device 505 to discharge a liquid onto the continuous medium 510 to form an image on the continuous medium 510, a dryer 507 to dry the continuous medium 510, and a carrier 509 to feeds the dried continuous medium 510 outward.

The continuous medium 510 (i.e., a medium or an object) is fed from a winding roller 511 of the feeder 501, guided and conveyed with rollers of the feeder 501, the guide conveyor 503, the dryer 507, and the carrier 509, and wound around a take-up roller 591 of the carrier 509. In the printing device 505, the continuous medium 510 is conveyed on a conveyance guide 559 so as to face a head unit 550. The head unit 550 discharges a liquid onto the continuous medium 510 to form an image.

As illustrated in FIG. 13, the head unit 550 includes two head modules 100A and 100B on a common base 552. The head module 100A includes head arrays 1A1, 1B1, 1A2, and 1B2. Each of the head arrays 1A1, 1B1, 1A2, and 1B2 includes multiple liquid discharge heads 101 arranged in a head array direction perpendicular to a conveyance direction of the continuous medium 510 indicated by the arrow in FIG. 13. The head module 100B includes head arrays 1C1, 1D1, 1C2, and 1D2. Each of the head arrays 1C1, 1D1, 1C2, and 1D2 includes multiple liquid discharge heads 101 arranged in the head array direction. The head arrays 1A1 and 1A2 of the head module 100A discharge a liquid of the same color. Similarly, the head arrays 1B1 and 1B2 of the head module 100A are grouped as one set and discharge a liquid of the same desired color. The head arrays 1C1 and 1C2 of the head module 100B are grouped as one set and discharge a liquid of the same desired color. The head arrays 1D1 and 1D2 of the head module 100B are grouped as one set and discharge a liquid of the same desired color.

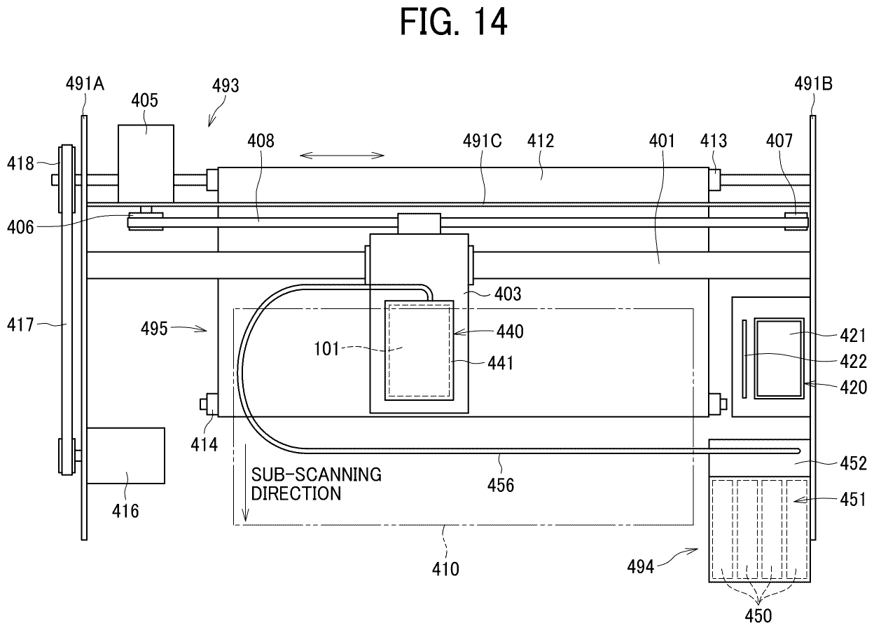

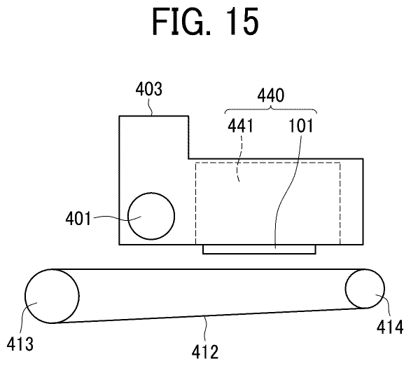

Another liquid discharge apparatus will be described below with reference to FIGS. 14 and 15. FIG. 14 is a plan view of a part of the liquid discharge apparatus. FIG. 15 is a side view of the part of the liquid discharge apparatus.

The liquid discharge apparatus is a serial-type apparatus in which a main-scanning moving mechanism 493 reciprocates a carriage 403 in a main scanning direction indicated by the double-headed arrow in FIG. 14. The main-scanning moving mechanism 493 includes, for example, a guide 401, a main scanning motor 405, and a timing belt 408. The guide 401 is bridged between left and right side plates 491A and 491B to movably hold the carriage 403. The main scanning motor 405 reciprocates the carriage 403 in the main scanning direction via the timing belt 408 looped around a drive pulley 406 and a driven pulley 407.

The carriage 403 includes a liquid discharge unit 440 in which a liquid discharge head 101 and a head tank 441 are integrated into a single unit. The liquid discharge head 101 of the liquid discharge unit 440 discharges color liquid of, for example, yellow (Y), cyan (C), magenta (M), or black (K). The liquid discharge head 101 is mounted on the liquid discharge unit 440 of the carriage 403 such that a row of the multiple nozzles 11 is arrayed in the sub-scanning direction perpendicular to the main scanning direction. The liquid discharge head 101 discharges the color liquid downward. For example, the above-described liquid discharge head 101 can be used as the liquid discharge head 101.

A supply mechanism 494 disposed outside the liquid discharge head 101 supplies liquid stored in liquid cartridges 450 to the head tank 441 to supply the liquid to the liquid discharge head 101. The supply mechanism 494 includes a cartridge holder 451 which is a loading device to mount the liquid cartridges 450, a tube 456, and a liquid feed unit 452 including a liquid feed pump. The liquid cartridge 450 is detachably mounted on the cartridge holder 451. The liquid feed unit 452 feeds the liquid from the liquid cartridge 450 to the head tank 441 via the tube 456.

The liquid discharge apparatus further includes a conveyance mechanism 495 to convey a sheet 410 (i.e., a medium or an object). The conveyance mechanism 495 includes a conveyance belt 412 (i.e., a conveyor) and a sub-scanning motor 416 to drive the conveyance belt 412. The conveyance belt 412 attracts the sheet 410 and conveys the sheet 410 to a position facing the liquid discharge head 101. The conveyance belt 412 is an endless belt looped around a conveyance roller 413 and a tension roller 414. The sheet 410 can be attracted to the conveyance belt 412 by, for example, electrostatic attraction or air suction. The conveyance belt 412 circumferentially moves in the sub-scanning direction as the conveyance roller 413 is rotationally driven by the sub-scanning motor 416 via a timing belt 417 and a timing pulley 418.

On one end of the range of movement of the carriage 403 in the main scanning direction, a maintenance mechanism 420 that maintains and recovers the liquid discharge head 101 is disposed lateral to the conveyance belt 412. The maintenance mechanism 420 includes, for example, a cap 421 to cap the nozzle face (i.e., the surface on which the nozzles 11 are formed) of the liquid discharge head 101 and a wiper 422 to wipe the nozzle face.

The main-scanning moving mechanism 493, the supply mechanism 494, the maintenance mechanism 420, and the conveyance mechanism 495 are mounted onto a housing including the side plates 491A and 491B and a back plate 491C.

In the liquid discharge apparatus having the above-described configuration, the sheet 410 is fed and attracted onto the conveyance belt 412 and conveyed in the sub-scanning direction as the conveyance belt 412 circumferentially moves.

The liquid discharge head 101 is driven in response to an image signal while the carriage 403 moves in the main scanning direction to discharge liquid onto the sheet 410 not in motion. As a result, an image is formed on the sheet 410.

As described above, the liquid discharge apparatus includes the liquid discharge head, thus allowing the stable formation of high-quality images.

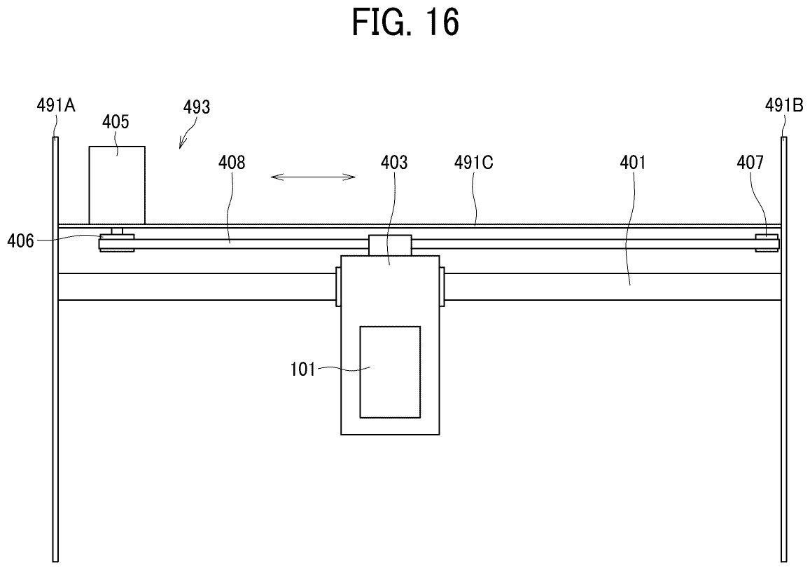

Another liquid discharge unit is described below with reference to FIG. 16. FIG. 16 is a plan view of a part of the liquid discharge unit. The liquid discharge unit includes the housing, the main-scanning moving mechanism 493, the carriage 403, and the liquid discharge head 101 among the components of the liquid discharge apparatus described above. The side plates 491A and 491B, and the back plate 491C construct the housing. The main-scanning moving mechanism 493 moves the carriage 403 in the main scanning direction indicated by the double-headed arrow in FIG. 16. The liquid discharge unit may further include at least one of the maintenance mechanism 420 or the supply mechanism 494, which may be attached to the side plate 491B.

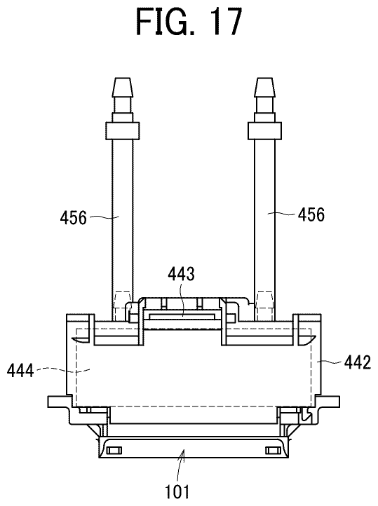

Still another liquid discharge unit is described below with reference to FIG. 17. FIG. 17 is a front view of the liquid discharge unit. The liquid discharge unit includes the liquid discharge head 101 to which a channel component 444 is attached, and tubes 456 connected to the channel component 444. The channel component 444 is disposed inside a cover 442. Alternatively, the liquid discharge unit 440 may include the head tank 441 instead of the channel component 444. A connector 443 for electrically connecting to the liquid discharge head 101 is disposed on an upper portion of the channel component 444.

The above-described embodiments are illustrative and do not limit the present disclosure. Numerous additional modifications and variations are possible in light of the above teachings. It is therefore to be understood that within the scope of the appended claims.

In the present disclosure, the term “liquid discharge apparatus” includes a liquid discharge head or a liquid discharge device (unit) and drives the liquid discharge head to discharge liquid. The term “liquid discharge apparatus” used herein includes, in addition to apparatuses to discharge liquid to a medium onto which liquid can adhere, apparatuses to discharge the liquid into gas (air) or a different liquid.

For example, the “liquid discharge apparatus” may further include devices relating to feeding, conveying, and ejecting of the medium onto which liquid can adhere and also include a pretreatment device and an aftertreatment device.

The “liquid discharge apparatus” may be, for example, an image forming apparatus to form an image on a sheet by discharging ink, or a three-dimensional fabrication apparatus to discharge fabrication liquid to a powder layer in which powder material is formed in layers to form a three-dimensional object.

The “liquid discharge apparatus” is not limited to an apparatus that discharges liquid to visualize meaningful images such as letters or figures. For example, the discharge apparatus may be an apparatus that forms patterns having no meaning or an apparatus that fabricates three-dimensional images.

The above-described term “medium onto which liquid can adhere” represents a medium on which liquid is at least temporarily adhered, a medium on which liquid is adhered and fixed, or a medium into which liquid adheres and permeates. Specific examples of the “medium onto which liquid can adhere” include, but are not limited to, a recording medium such as a paper sheet, recording paper, a recording sheet of paper, a film, or cloth, an electronic component such as an electronic substrate or a piezoelectric element, and a medium such as layered powder, an organ model, or a testing cell. The “medium onto which liquid can adhere” includes any medium to which liquid adheres, unless otherwise specified.

Examples of materials of the “medium onto which liquid can adhere” include any materials to which liquid can adhere even temporarily, such as paper, thread, fiber, fabric, leather, metal, plastic, glass, wood, ceramic, construction materials (e.g., wallpaper or floor material), and cloth textile.

Examples of the “liquid” include ink, treatment liquid, deoxyribonucleic acid (DNA) sample, resist, pattern material, binder, fabrication liquid, and solution or liquid dispersion containing amino acid, protein, or calcium.

The term “liquid discharge apparatus” may be an apparatus in which the liquid discharge head and the medium onto which liquid can adhere move relative to each other.

However, the liquid discharge apparatus is not limited to such an apparatus. For example, the liquid discharge apparatus may be a serial head apparatus that moves the liquid discharge head or a line head apparatus that does not move the liquid discharge head.

Examples of the liquid discharge apparatus further include: a treatment liquid applying apparatus that discharges a treatment liquid onto a sheet to apply the treatment liquid to the surface of the sheet, for reforming the surface of the sheet; and an injection granulation apparatus that injects a composition liquid, in which a raw material is dispersed in a solution, through a nozzle to granulate fine particles of the raw material.

The “liquid discharge unit” refers to a liquid discharge head integrated with functional components or mechanisms, i.e., an assembly of components related to liquid discharge. For example, the “liquid discharge unit” includes a combination of the liquid discharge head with at least one of a head tank, a carriage, a supply mechanism, a maintenance mechanism, or a main-scanning moving mechanism.

The above integration may be achieved by, for example, a combination in which the liquid discharge head and a functional component(s) or mechanism(s) are fixed to each other through, e.g., fastening, bonding, or engaging, and a combination in which one of the liquid discharge head and the functional component(s) or mechanism(s) is movably held by the other. The liquid discharge head and the functional component(s) or mechanism(s) may be detachably attached to each other.

Examples of the liquid discharge unit include the liquid discharge unit 440 in which a head module (liquid discharge head) and a head tank are integrated, as illustrated in FIG. 15. Alternatively, the liquid discharge head and the head tank coupled (connected) to each other via, for example, a tube may form the liquid discharge unit as a single unit. A unit including a filter may further be added to a portion between the head tank and the liquid discharge head of the liquid discharge unit.

In another example, the liquid discharge unit may be an integrated unit in which a liquid discharge head is integrated with a carriage.

As yet another example, the liquid discharge unit is a unit in which the liquid discharge head and the main-scanning moving mechanism are combined into a single unit. The liquid discharge head is movably held by a guide that is a part of the main-scanning moving mechanism. Like the liquid discharge unit illustrated in FIG. 16, the liquid discharge head, the carriage, and the main-scanning moving mechanism may form the liquid discharge unit as a single unit.

In another example, the cap that forms a part of the maintenance mechanism is fixed to the carriage mounting the liquid discharge head so that the liquid discharge head, the carriage, and the maintenance mechanism are integrated as a single unit to form the liquid discharge unit.

Further, in still another example, the liquid discharge unit includes tubes connected to the liquid discharge head to which the head tank or the channel component is attached so that the liquid discharge head and the supply mechanism are integrated as a single unit, as illustrated in FIG. 17.

The main-scanning moving mechanism may be a guide only. The supply mechanism may be a tube(s) only or a loading device only.

The pressure generator used in the liquid discharge head is not limited to a particular type of pressure generator. The pressure generator is not limited to the piezoelectric actuator (or a laminated-type piezoelectric element) described in the above-described embodiments, and may be, for example, a thermal actuator that employs a thermoelectric transducer element, such as a thermal resistor, or an electrostatic actuator including a diaphragm and opposed electrodes.

In the present specification, the terms “image formation,” “recording,” “printing,” “image printing,” and “fabricating” used herein may be used synonymously with each other.

Aspects of the present disclosure are, for example, as follows.

### Aspect 1

A liquid discharge head includes a nozzle member, a pressure chamber member, a first substrate, and a second substrate. The nozzle member has multiple nozzles. The pressure chamber member has a pressure chamber communicating with the nozzles. The first substrate has a common channel. The second substrate is joined to the first substrate on a side opposite to a side of the pressure chamber member. The first substrate has a first high rigidity portion and a first low rigidity portion having lower rigidity than rigidity of the first high rigidity portion. The second substrate has a second high rigidity portion and a second low rigidity portion having lower rigidity than rigidity of the second high rigidity portion. The first high rigidity portion is joined to the second low rigidity portion, and the first low rigidity portion is joined to the second high rigidity portion.

In other words, a liquid discharge head includes a nozzle substrate, a pressure chamber substrate, a first substrate, and a second substrate. The nozzle substrate has multiple nozzles. The pressure chamber substrate is disposed over the nozzle substrate. The pressure chamber substrate has pressure chambers respectively communicating with the multiple nozzles. The first substrate is disposed over the pressure chamber substrate. The first substrate has a common channel communicating with each of the pressure chambers, a first face opposed to the pressure chamber substrate, a second face opposite the first face, a first rigidity portion having a first rigidity, and a second rigidity portion having a second rigidity lower than the first rigidity. The second substrate is disposed over the first substrate. The second substrate has a third face opposed to the second face of the first substrate, a fourth face opposite the third face, a third rigidity portion having a third rigidity, and a fourth rigidity portion having a fourth rigidity lower than the third rigidity. The third rigidity portion is joined to the second rigidity portion of the first substrate, and the fourth rigidity portion is joined to the first rigidity portion of the first substrate.

### Aspect 2

In the liquid discharge head according to Aspect 1, a variation in rigidity of the first substrate and the second substrate in a state of being joined to each other is smaller than a variation in rigidity of the first substrate alone at positions on a plane orthogonal to a lamination direction of the first substrate and the second substrate.

In other words, the second substrate is laminated over the first substrate in a lamination direction orthogonal to a plane of the first substrate. The first substrate has a first variation in rigidity that varies across the plane of the first substrate. The first substrate jointed to the second substrate forms a holding substrate having a second variation in rigidity that varies across the plane of the first substrate. The second variation is smaller than the first variation.

### Aspect 3

In the liquid discharge head according to Aspect 1 or 2, the first substrate and the second substrate have an uneven shape including a projection and a recess. The first substrate and the second substrate are joined to each other in a state where the projection of the first substrate and the recess of the second substrate overlap each other and the recess of the first substrate and the projection of the second substrate overlap each other as viewed in a lamination direction of the first substrate and the second substrate.

In other words, the second substrate is laminated over the first substrate and joined to the first substrate in a lamination direction orthogonal to a plane of the first substrate. The first substrate has a first uneven shape including a first projection projecting in the lamination direction and forming a first wall portion and a first recess forming a bottom of the first wall portion. The second substrate has a second uneven shape including a second projection projecting in the lamination direction and forming a second wall portion and a second recess forming a bottom of the second wall portion. The second projection is overlapped with the first recess in the lamination direction in a plan view of the first substrate, and the second recess is overlapped with the first projection in the lamination direction in the plan view of the first substrate.

### Aspect 4

In the liquid discharge head according to Aspect 3, the uneven shape of the first substrate overlaps the uneven shape of the second substrate when the first substrate is rotated by 180 degrees about an axis parallel to a transverse direction of the first substrate as viewed in the lamination direction of the first substrate and the second substrate.

In other words, the first wall portion extends in a longitudinal direction of the first substrate. The second uneven shape coincides with the first uneven shape, rotated by 180 degrees about a central axis parallel to a transverse direction of the first substrate orthogonal to the longitudinal direction and the lamination direction, in the plan view of the first substrate. The central axis is at the center of the first substrate in the longitudinal direction.

### Aspect 5

In the liquid discharge head according to Aspect 3 or 4, when a distance in a thickness direction from the projection to the recess in the first substrate and the second substrate is defined as a recess depth, the recess depth of the second substrate is deeper than the recess depth of the first substrate.

In other words, the first recess has a first depth from a top of the first projection to the bottom of the first wall portion in the lamination direction. The second recess has a second depth from a top of the second projection to the bottom of the second wall portion in the lamination direction. The second depth is deeper than the first depth.

### Aspect 6

In the liquid discharge head according to any one of Aspects 3 to 5, the uneven shape of the second substrate is formed on a side of a face of the second substrate opposite to a side of the first substrate.

In other words, the second substrate has the second uneven shape on the fourth face of the second substrate.

### Aspect 7

In the liquid discharge head according to any one of Aspects 3 to 6, the common channel is formed by the uneven shape of the first substrate. The common channel includes a branch flow section extending in a direction inclined with respect to a longitudinal direction and a transverse direction of the first substrate. The uneven shape of the second substrate is a rigidity adjuster to adjust rigidity of the second substrate and includes an inclined portion inclined in a direction opposite to the branch flow section.

In other words, the first wall portion forms the common channel including a first branch channel extending in a first inclined direction inclined with respect to the longitudinal direction and the transverse direction of the first substrate. The second wall portion forms a pseudo channel including a second branch channel extending in a second inclined direction, different from the first inclined direction, inclined with respect to the longitudinal direction and the transverse direction.

In addition, the second uneven shape is a rigidity adjuster to adjust rigidity of the second substrate.

### Aspect 8

The liquid discharge head according to any one of Aspects 1 to 7, further includes a damper. The first substrate and the second substrate are joined to each other via the damper. In other words, the first substrate is joined to the second substrate via the damper.

### Aspect 9

In the liquid discharge head according to Aspect 8, the damper includes a damper-side common channel that communicates with the common channel of the first substrate to integrally forms a liquid channel. The first substrate and the second substrate have an uneven shape including a projection and a recess. When a distance in a thickness direction from the projection to the recess in the second substrate is defined as a recess depth, and a total depth of the common channel and the damper-side common channel is defined as a common channel depth, the recess depth of the second substrate is deeper than the common channel depth.

In other words, the second substrate is laminated over the first substrate in a lamination direction orthogonal to a plane of the first substrate. The damper has a damper-side common channel communicating with the common channel of the first substrate to form a combined liquid channel including the common channel and the damper-side common channel. The damper-side common channel having a damper depth. The first substrate has a first uneven shape including a first projection projecting in the lamination direction and forming a first wall portion and a first recess forming a bottom of the first wall portion. The first recess has a first depth from a top of the first projection to the bottom of the first wall portion in the lamination direction. The second substrate has a second uneven shape including a second projection projecting in the lamination direction and forming a second wall portion and a second recess forming a bottom of the second wall portion. The second recess has a second depth from a top of the second projection to the bottom of the second wall portion in the lamination direction. The second depth is deeper than a sum of the first depth and the damper depth.

### Aspect 10

In the liquid discharge head according to any one of Aspects 1 to 9, each of the first substrate and the second substrate is equally divided into two in a longitudinal direction and a transverse direction of the first substrate and the second substrate to divide each of the first substrate and the second substrate into four regions. When two regions having high rigidity in the first substrate are defined as a first high rigidity region, two regions having low rigidity in the first substrate are defined as a first low rigidity region, two regions having high rigidity in the second substrate are defined as a second high rigidity region, and two regions having low rigidity in the second substrate are defined as a second low rigidity region, the first high rigidity region and the second low rigidity region are joined to each other, and the first low rigidity region and the second high rigidity region are joined to each other.

In other words, the first substrate is divided into first four regions by center positions in a longitudinal direction and a transverse direction of the first substrate. The first four regions include two first rigidity portions including the first rigidity portion and two second rigidity portions including the second rigidity portion. The second substrate is divided into second four regions by center positions in a longitudinal direction and a transverse direction of the second substrate. The second four regions include two third rigidity portions including the third rigidity portion and two fourth rigidity portions including the fourth rigidity portion. The two first rigidity portions are joined to the two fourth rigidity portions, respectively, and the two second rigidity portions are joined to the two third rigidity portions, respectively.

### Aspect 11

In the liquid discharge head according to Aspect 10, a thickness of a portion of the second substrate joined to the first low rigidity region is larger than a thickness of a portion of the second substrate joined to the first high rigidity region.

In other words, a thickness of a portion of the second substrate joined to the second rigidity portion is larger than a thickness of a portion of the second substrate joined to the first rigidity portion.

### Aspect 12

A head module includes multiple liquid discharge heads including the liquid discharge head according to any one of Aspects 1 to 11.

### Aspect 13

A liquid discharge apparatus includes the liquid discharge head according to any one of Aspects 1 to 11.

In other words, a liquid discharge apparatus includes the liquid discharge head according to any one of Aspects 1 to 11, to discharge a liquid onto an object and a conveyor to convey the object to the liquid discharge head.

Alternatively, a liquid discharge apparatus includes the liquid discharge head according to any one of Aspects 1 to 11, to discharge a liquid onto an object and a carriage mounting the liquid discharge head to move the liquid discharge head relative to the object.

As described above, according to one aspect of the present disclosure, deformation of the first substrate can be prevented.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A liquid discharge head comprising:
a nozzle substrate having multiple nozzles;
a pressure chamber substrate over the nozzle substrate,
the pressure chamber substrate having pressure chambers respectively communicating with the multiple nozzles;
a first substrate over the pressure chamber substrate, the first substrate having:
a common channel communicating with each of the pressure chambers;
a first face opposed to the pressure chamber substrate;
a second face opposite the first face;
a first rigidity portion having a first rigidity; and
a second rigidity portion having a second rigidity lower than the first rigidity; and
a second substrate over the first substrate, the second substrate having:
a third face opposed to the second face of the first substrate;
a fourth face opposite the third face;
a third rigidity portion having a third rigidity, the third rigidity portion joined to the second rigidity portion of the first substrate; and
a fourth rigidity portion having a fourth rigidity lower than the third rigidity, the fourth rigidity portion joined to the first rigidity portion of the first substrate.

2. The liquid discharge head according to claim 1,
wherein the second substrate is laminated over the first substrate in a lamination direction orthogonal to a plane of the first substrate,
the first substrate has a first variation in rigidity that varies across the plane of the first substrate,
the first substrate jointed to the second substrate forms a holding substrate having a second variation in rigidity that varies across the plane of the first substrate, and
the second variation is smaller than the first variation.

3. The liquid discharge head according to claim 1,
wherein the second substrate is laminated over the first substrate and joined to the first substrate in a lamination direction orthogonal to a plane of the first substrate,
the first substrate has a first uneven shape including:
a first projection projecting in the lamination direction and forming a first wall portion; and
a first recess forming a bottom of the first wall portion, and
the second substrate has a second uneven shape including:
a second projection projecting in the lamination direction and forming a second wall portion, the second projection overlapped with the first recess in the lamination direction in a plan view of the first substrate; and
a second recess forming a bottom of the second wall portion, the second recess overlapped with the first projection in the lamination direction in the plan view of the first substrate.

4. The liquid discharge head according to claim 3,
wherein the first wall portion extends in a longitudinal direction of the first substrate,
the second uneven shape coincides with the first uneven shape, rotated by 180 degrees about a central axis parallel to a transverse direction of the first substrate orthogonal to the longitudinal direction and the lamination direction, in the plan view of the first substrate,
the central axis is at the center of the first substrate in the longitudinal direction.

5. The liquid discharge head according to claim 3,
wherein the first recess has a first depth from a top of the first projection to the bottom of the first wall portion in the lamination direction,
the second recess has a second depth from a top of the second projection to the bottom of the second wall portion in the lamination direction, and
the second depth is deeper than the first depth.

6. The liquid discharge head according to claim 3,
wherein the second substrate has the second uneven shape on the fourth face of the second substrate.

7. The liquid discharge head according to claim 4,
wherein the first wall portion forms the common channel including a first branch channel extending in a first inclined direction inclined with respect to the longitudinal direction and the transverse direction of the first substrate,
the second wall portion forms a pseudo channel including a second branch channel extending in a second inclined direction, different from the first inclined direction, inclined with respect to the longitudinal direction and the transverse direction.

8. The liquid discharge head according to claim 7,
wherein the second uneven shape is a rigidity adjuster to adjust rigidity of the second substrate.

9. The liquid discharge head according to claim 1, further comprising a damper,
wherein the first substrate is joined to the second substrate via the damper.

10. The liquid discharge head according to claim 9,
wherein the second substrate is laminated over the first substrate in a lamination direction orthogonal to a plane of the first substrate,
the damper has a damper-side common channel communicating with the common channel of the first substrate to form a combined liquid channel including the common channel and the damper-side common channel, the damper-side common channel having a damper depth,
the first substrate has a first uneven shape including:
a first projection projecting in a lamination direction and forming a first wall portion; and
a first recess forming a bottom of the first wall portion, the first recess having a first depth from a top of the first projection to the bottom of the first wall portion in the lamination direction,
the second substrate has a second uneven shape including:
a second projection projecting in the lamination direction and forming a second wall portion; and
a second recess forming a bottom of the second wall portion, the second recess having a second depth from a top of the second projection to the bottom of the second wall portion in the lamination direction, and
the second depth is deeper than a sum of the first depth and the damper depth.

11. The liquid discharge head according to claim 1,
wherein the first substrate is divided into first four regions by center positions in a longitudinal direction and a transverse direction of the first substrate,
the first four regions include:
two first rigidity portions including the first rigidity portion; and
two second rigidity portions including the second rigidity portion,
the second substrate is divided into second four regions by center positions in a longitudinal direction and a transverse direction of the second substrate,
the second four regions include:
two third rigidity portions including the third rigidity portion; and
two fourth rigidity portions including the fourth rigidity portion,
the two first rigidity portions are joined to the two fourth rigidity portions, respectively, and
the two second rigidity portions are joined to the two third rigidity portions, respectively.

12. The liquid discharge head according to claim 11,
wherein a thickness of a portion of the second substrate joined to the second rigidity portion is larger than a thickness of a portion of the second substrate joined to the first rigidity portion.

13. A head module comprising multiple liquid discharge heads including the liquid discharge head according to claim 1.

14. A liquid discharge apparatus comprising:
the liquid discharge head according to claim 1, to discharge a liquid onto an object; and
a conveyor to convey the object to the liquid discharge head.

15. A liquid discharge apparatus comprising:
the liquid discharge head according to claim 1, to discharge a liquid onto an object; and
a carriage mounting the liquid discharge head to move the liquid discharge head relative to the object.
